(19) United States
(12) Patent Application Publication
(10) Pub. No.: US 2013/0122757 A1
(43) Pub. Date: May 16, 2013

(54) ELECTRICAL CONNECTOR AND TERMINAL

(71) Applicants: SHENG-YUAN HUANG, New Taipei (TW); Chih-hsien Chiang, New Taipei (TW); Sheng-nan Yu, New Taipei (TW)

(72) Inventors: SHENG-YUAN HUANG, New Taipei (TW); Chih-hsien Chiang, New Taipei (TW); Sheng-nan Yu, New Taipei (TW)

(73) Assignee: Cheng Uei Precision Industry Co., LTD., New Taipei City (TW)

(21) Appl. No.: 13/294,985

(22) Filed: Nov. 11, 2011

(51) Int. Cl. H01R 13/40

(52) U.S. Cl. 439/733.1

(57) ABSTRACT

An electrical connector and a terminal are provided. The electrical connector includes an insulating housing and a plurality of terminals. The insulating housing defines a plurality of terminal-receiving grooves. The terminals are located in the terminal-receiving grooves. Each of the terminals includes a solder portion, a receiving space formed by bending and extending the solder portion and provided for a complementary terminal inserted therein, a contact portion located at an opening of the receiving space and provided for contacting with the complementary terminal, and at least two protrusions respectively formed on two sides of the contact portion. The electrical connector and the terminal of the present invention can prevent the deformation of the terminal during the course of inserting and unplugging so that improving the electrical performance and prolonging the service life.

### BACKGROUND OF THE INVENTION

1. Field of the Invention

The present invention relates to a connector field, and more particularly to an electrical connector and a terminal thereof, which can prevent the deformation of the terminal when being inserted and unplugged, improve the electrical performance and prolong the service life.

2. Description of the Prior Art

A connector is widely used in many fields, such as traffic, communication, network, information technology (IT), medical treatment, household electric appliance and so on. With the rapid development of the technology and the rapid increase of the market, the technology of the connector is powerfully developed. Up to the present, the connectors are developed to be diversification, serialization and specialization.

The fundamental performance of the electrical connector includes the mechanical performance, the electrical performance and the environment performance. The mechanical performance refers to a mechanical life of the electrical connector. Actually, the mechanical life is a durable index, which is based on a insert and an unplug as a cycle and then needs to judge whether the electrical connector still can normally realize the connection function, such as contact resistance values, after the required cycles of the inserting and the unplugging. Therefore, when the mechanical performance of the electrical connector is damaged, the electrical performance is generally influenced. Please refer to FIG. 1, which shows two complementary terminals of two complementary connectors, the terminal 1 is inserted into the terminal 2. When the terminal 1 is inserted into and unplugged from the terminal 2 over a long period of time, the terminals 1, 2 (especially the terminal 2) are easy to generate the deformation, so that resulting in the bad contact of the terminals 1, 2 and effecting the electrical performance of the two connectors.

Hence, it urgently needs to provide an electrical connector and a terminal thereof, which can prevent the deformation of the terminal when being inserted and unplugged, improve the electrical performance and prolong the service life.

### BRIEF SUMMARY OF THE INVENTION

One object of the present invention is to provide an electrical connector, being capable of preventing the deformation of the terminal when being inserted and unplugged, improving the electrical performance and prolonging the service life.

Another object of the present invention is to provide a terminal, being capable of preventing the deformation of the terminal when being inserted and unplugged, improving the electrical performance and prolonging the service life.

To achieve the above objects, in accordance with the present invention, an electrical connector is provided, comprising an insulating housing and a plurality of terminals. The insulating housing defines a plurality of terminal-receiving grooves. The terminals are located in the terminal-receiving grooves. Each of the terminals comprises a solder portion, a receiving space formed by bending and extending the solder portion and provided for a complementary terminal inserted therein, a contact portion located at an opening of the receiving space and provided for contacting with the complementary terminal, and at least two protrusions respectively formed on two sides of the contact portion.

Preferably, the protrusions are integrally formed on the two sides of the contact portion in one-piece.

Preferably, the protrusions are step-shaped.

To achieve the above objects, in accordance with the present invention, a terminal is provided. The terminal comprises a solder portion, a receiving space formed by bending and extending the solder portion and provided for a complementary terminal inserted therein, a contact portion located at an opening of the receiving space and provided for contacting with the complementary terminal, and at least two protrusions respectively formed on two sides of the contact portion.

Based on the above description, the electrical connector and the terminal of the present invention dispose the protrusions on the two sides of the contact portion of the terminal, so that preventing the deformation of the inserting space of the terminal when the complementary terminal being repeatedly inserted into and pulled out of the receiving space. Accordingly, the electrical connector and the terminal of the present invention can well improve the electrical performance and prolong the service life.

The present invention will be more clarity by the following description with reference to the accompanying drawings. The following accompanying drawings are used to explain the embodiment of the present invention, but not to limit it.

### BRIEF DESCRIPTION OF THE DRAWINGS

FIG. 1 is a structure schematic view of a terminal and a complementary terminal in the prior art.

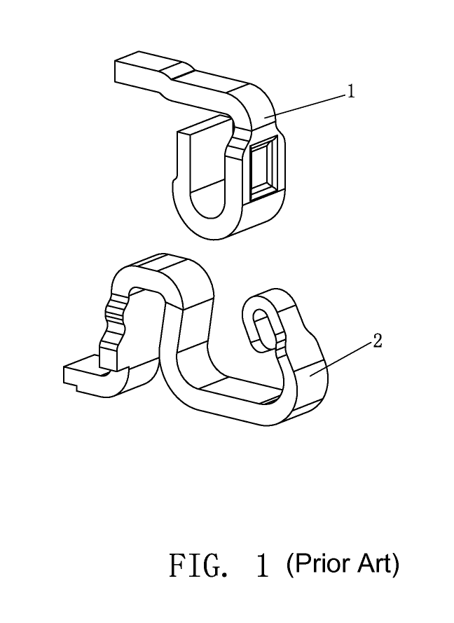

FIG. 2 is a structure schematic view of a terminal and a complementary terminal in the present invention.

FIG. 3 is a perspective view of an electrical connector and a complementary connector mated with each other in one embodiment of the present invention.

FIG. 4 is an exploded view of the electrical connector and the complementary connector shown in FIG. 3.

FIG. 5 is a top view of the electrical connector and the complementary connector shown in FIG. 3

FIG. 6 is a sectional view taken on line A-A of FIG. 5.

### DETAILED DESCRIPTION OF THE PREFERRED EMBODIMENTS

Now, the following embodiment with reference to the accompanying drawings will be detail described. The similar numeral shown in the drawings represent the similar element.

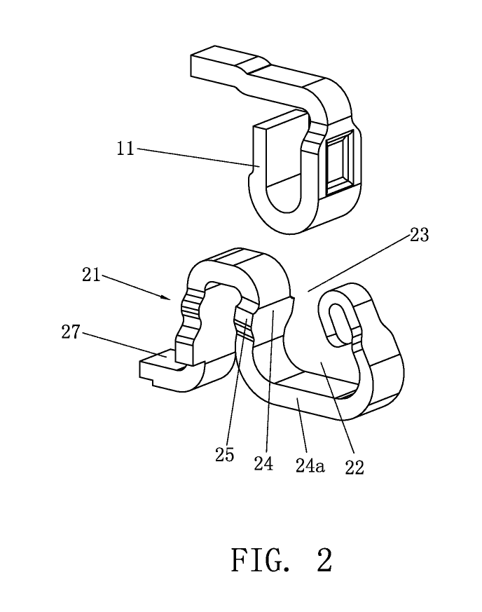

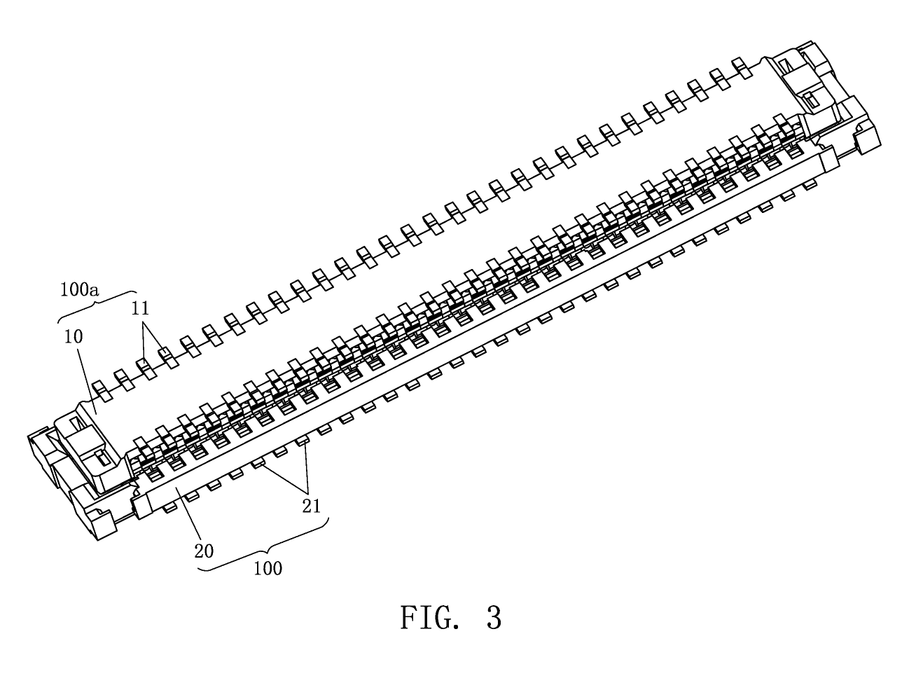

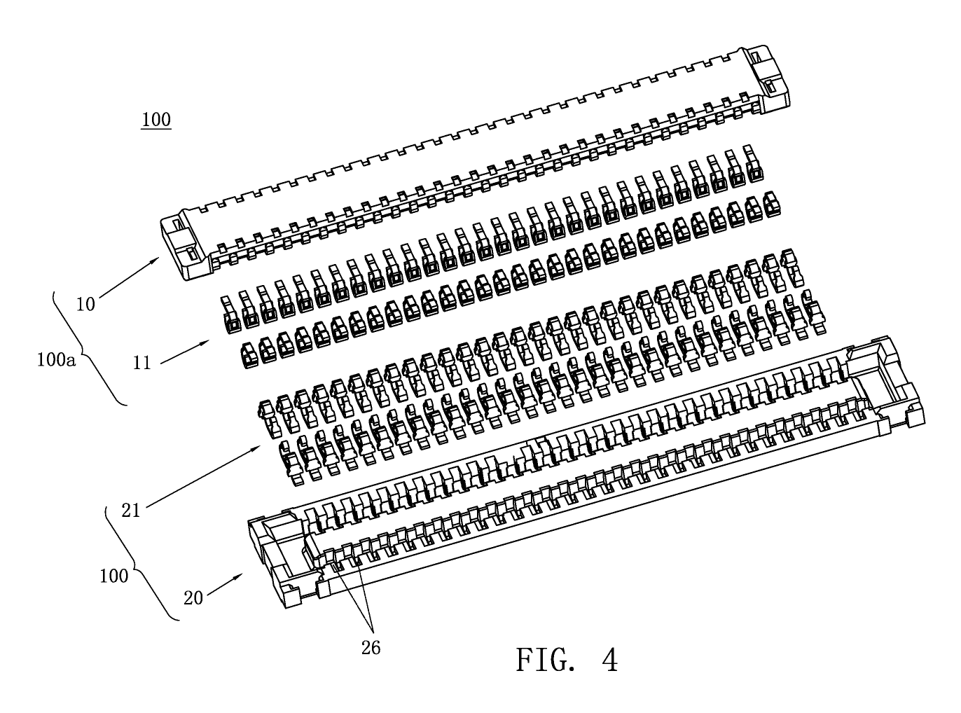

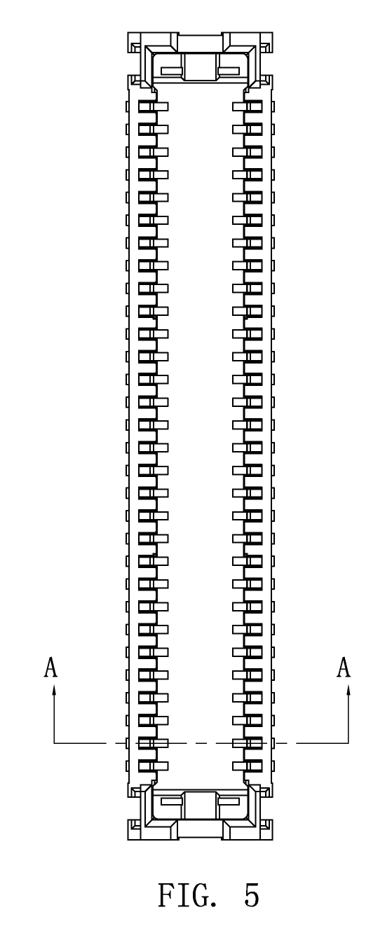

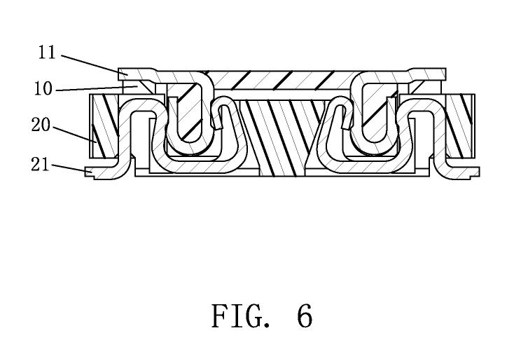

Please refer to FIGS. 2 to 4, an electrical connector 100 of the present invention is used to be mated with a complementary connector 100a. The complementary connector 100a comprises a complementary insulating housing 10 and a plurality of complementary terminals 11. The electrical connector 100 comprises an insulating housing 20 and a plurality of terminals 21. The insulating housing 20 defines a plurality of terminal-receiving grooves 26, in which the terminals 21 are fixed. Each terminal 21 includes a solder portion 27, a receiving space 22 formed by extending and bending the solder portion 27 and provided for the complementary terminal 11 inserted therein, a contact portion 24 located at an opening 23 of the receiving space 22 and provided for contacting with the complementary terminal 11, and at least two protrusions respectively formed on two sides 24a of the contact portion 24. Please refer to FIGS. 2, 5 and 6, when the complementary terminal 11 is inserted into the terminal-receiving groove 26 of the electrical connector 100, the opening 23 of the receiving space 22 of the terminal 21 located in the terminal-receiving groove 26 will propped open by the complementary terminal 11, and the opening 23 will tightly clamp the complementary terminal 11 for forming an electrical connection between the terminal 21 and the complementary terminal 11. After the complementary terminal 11 is pulled out of the terminal-receiving groove 26, the opening 23 will restore the original state. When the complementary terminal 11 is repeatedly inserted into and pulled out of the receiving space 22 of the terminal 21, the opening 23 of the terminal 21 can not be deformed because the protrusions 25 of the contact portion 24 located at the opening 23 is fixed on the insulating housing 20.

Please refer to FIG. 2, the protrusions 25 and the two sides 24a are integrally formed in one-piece.

Please refer to FIG. 2, the protrusions 25 are step-shaped.

Please refer to FIG. 2, the present invention also provides a terminal 21, which includes a solder portion 27, a receiving space 22 formed by extending and bending the solder portion 27 and provided for the complementary terminal 11 inserted therein, a contact portion 24 located at an opening 23 of the receiving space 22 and provided for contacting with the complementary terminal 11, and at least two protrusions respectively formed on two sides 24a of the contact portion 24.

Please refer to FIGS. 2 to 6, the electrical connector 100 and the terminal 21 of the present invention dispose the protrusions 25 on the two sides 24a of the contact portion 24 of the terminal 21, so that preventing the deformation of the inserting space 22 of the terminal 21 when the complementary terminal 11 being repeatedly inserted into and pulled out of the receiving space 22. Accordingly, the electrical connector and the terminal of the present invention can well improve the electrical performance and prolong the service life.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising an insulating housing and a plurality of terminals, the insulating housing defining a plurality of terminal-receiving grooves, the terminals being located in the terminal-receiving grooves, each of the terminals comprising a solder portion, a receiving space formed by bending and extending the solder portion and provided for a complementary terminal inserted therein, a contact portion located at an opening of the receiving space and provided for contacting with the complementary terminal, and at least two protrusions respectively formed on two sides of the contact portion.

2. The electrical connector as claimed in claim 1, wherein the protrusions are integrally formed on the two sides of the contact portion in one-piece.

3. The electrical connector as claimed in claim 1, wherein the protrusions are step-shaped.
